(19) United States
(12) Patent Application Publication
(10) Pub. No.: US 2020/0226877 A1
(43) Pub. Date: Jul. 16, 2020

(54) GAME DEVICE

(71) Applicant: SEGA SAMMY CREATION INC., Kanagawa (JP)

(72) Inventors: Keiji Sugawara, Kanagawa (JP); Kenji Kuwahara, Kanagawa (JP); Kimio Tsuda, Kanagawa (JP); Souichi Aoki, Kanagawa (JP); Yasuhiro Aoki, Shizuoka (JP)

(21) Appl. No.: 16/630,976

(22) PCT Filed: Aug. 10, 2017
(86) PCT No.: PCT/JP2017/029189

§ 371 Date: Jan. 14, 2020

(51) Int. Cl. G07F 17/32; G09F 13/20

(52) U.S. Cl. CPC G07F 17/3216; G09F 2013/222; G09F 13/20

(57) ABSTRACT

In order to make a configuration which achieves a new appeal to viewers such as players by emitting light while having a simple structure, a light emitting device attached to a housing (2) constituting a game device (1) includes a tubular member (30) having flexibility and translucency, and a light source disposed in the tubular member (30). An installation member on which the tubular member (30) is installed is provided in the housing (2) of the game device (1). An attachment portion for installing the tubular member (30) on the installation member may be formed on the tubular member (30). An installation protrusion may be provided in the installation member, and the attachment portion of the tubular member (30) may be configured by a groove having the same shape as a cross-sectional shape of the protrusion for attachment.

### CROSS-REFERENCE TO RELATED APPLICATION

The present invention is a national phase entry of International Application No. PCT/JP2017/029189 filed Aug. 10, 2017, which is incorporated herein by reference in its entirety for all purposes.

### TECHNICAL FIELD

The present invention relates to a game device, and more particularly to a game device including a light emitting device in a housing.

### BACKGROUND ART

Conventionally, a game device including decorative illuminations such as various lightings and light emissions is used. Recently, a game housing in which a light emitting diode (LED) is provided on a main body has also been used.

Specifically, as such a game device or a game housing, for example, a game machine such as a slot machine including a conical groove for diffusing LED light has been known (Patent Literature 1). In order to cause a blindfold plate (for example, an acrylic plate) between several satellites (station machines) disposed around a large housing to emit light, a device configured to radiate light from one end of the acrylic plate into the acrylic plate or the like is used.

Conventionally, a game device including decorative illuminations such as various lightings and light emissions has been used. As such a game device, for example, a device configured to diffuse light radiated from a light source radially at a portion of the device and then reflect the light uniformly in a specific direction over the entire surface or the like is provided.

### SUMMARY

### Technical Problem

However, light emitting devices in conventional game devices look the same to players, and no device that achieves a new appealing effect due to light emissions has been found.

Therefore, an object of the present invention is to provide a game device which can achieve a new appeal for viewers such as players by emitting light while having a simple structure.

### Solution to Problem

In order to solve such a problem, the present invention has been conceived by the present inventors who considered many novel configurations and more distinctive production effects, and is a game device having a housing, which includes a tubular member having flexibility and light-transmitting property, and a light source disposed in the tubular member.

In the game device, a tube can be disposed in the housing in a state in which it is bent into a desired shape. In addition, the whole tube can emit light due to the light source incorporated in the tube. According to such a game device including a light emitting device having a structure in which the tube having flexibility and light-transmitting property emits light due to the incorporated light source, it is possible to provide a new and effective illumination effect that has never been provided before, for example, the novelty of an illumination resembling a fluorescent tube or neon tube shining, while employing a simple structure.

### Advantageous Effects of Invention

According to the present invention, it is possible to provide a game device which can achieve a new appeal for viewers such as players by emitting light while having a simple structure.

### BRIEF DESCRIPTION OF DRAWINGS

FIG. 1 is a perspective view showing an outline of a configuration of a game device according to an embodiment of the present invention.

FIG. 2 is a front view of the game device.

FIG. 3 is a right side view of the game device.

FIG. 4 is a cross-sectional view of a tubular member, a light source, an installation member, etc., taken along line IV-IV of FIG. 2.

FIG. 5 is a cross-sectional view of the tubular member, the light source, the installation member, etc., taken along line V-V of FIG. 3.

FIG. 6 is a perspective view of the game device in a state where the light emitting device is shining.

### DESCRIPTION OF EMBODIMENTS

Hereinafter, a configuration of the present invention will be described in detail based on an example of an embodiment shown in the figures.

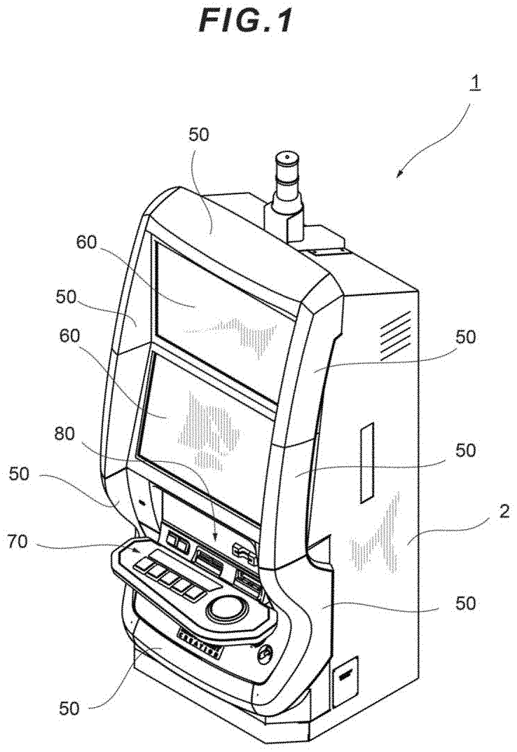

FIGS. 1 to 6 show an appearance and the like of a game device 1 according to the present embodiment. The game device 1 is used as a device for various games including as a device for a slot game (a slot machine). The game device 1 may also be used as one of a plurality of station machines (which may be called satellites) connected to a master machine (not shown) in a wired and/or wireless manner via a network such as a local area network (LAN), a wide area network (WAN), or the Internet.

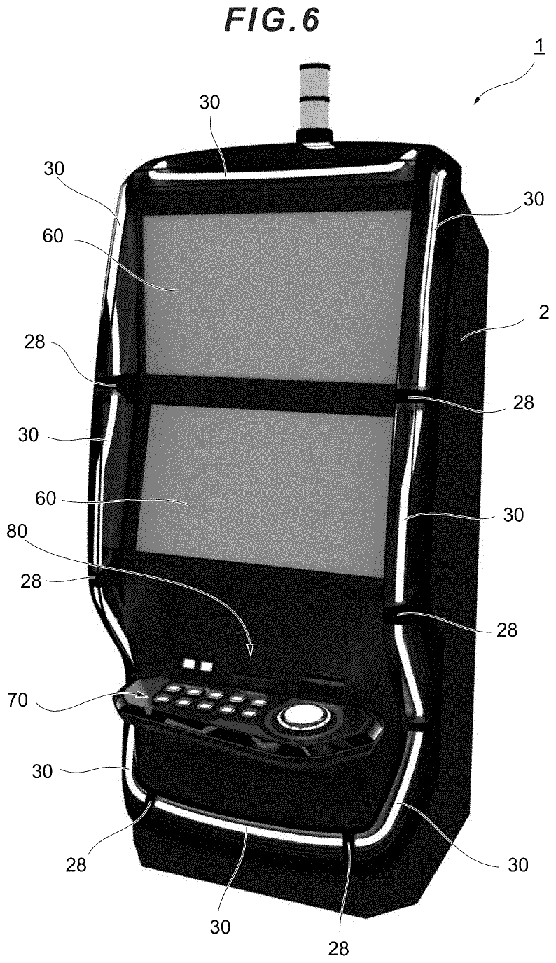

A game display unit 60 having two upper and lower screens, an operation input unit 70 for a player to input various operations, and a bill insertion/card reader unit 80 (see FIG. 1, etc.) are provided in a housing 2 of the game device 1, and installation members 22 and supporting members 28 are further provided therein (see FIG. 6, etc.). Light emitting devices 3 are attached to the housing 2 using the installation members 22 and the supporting members 28, and cover members 50 are further attached thereto.

The light emitting devices 3 in the game device 1 of the present embodiment include silicone tubes 30 and LEDs 40, and are configured to achieve the novelty of an illumination resembling a fluorescent tube or neon tube shining and to form a decorative body like an object with an illumination that attracts attention of viewers such as players.

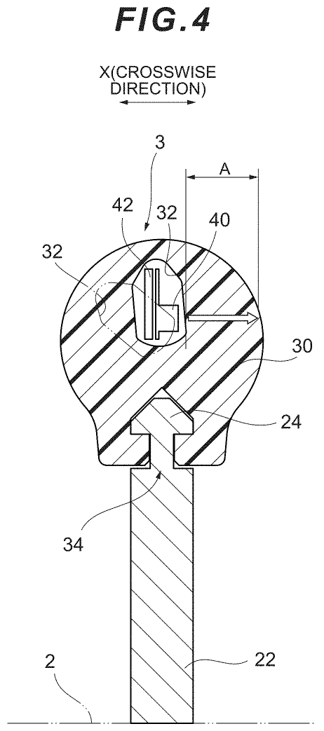

The LEDs 40 are appropriate examples of light sources that constitute the light emitting devices 3, and a plurality of LEDs 40 are disposed on a substrate 42, for example, along a straight line at equal intervals to form a light emitting module (an LED unit). The LED 40 in the game device 1 of the present embodiment is configured to radiate light in one direction perpendicular to a surface on the substrate 42 (see FIG. 4, etc.). LEDs with different luminescent colors may be employed to enable light emission in plural colors. In addition, a production in which the light emitting device 3 is turned on or off may be performed by blinking the LED 40.

The substrate 42 is configured of a material having flexibility and can be bent in a thickness direction thereof. In addition, the substrate 42 can be twisted within a certain range. Therefore, it is possible to install the silicone tube 30 with the substrate 42 in a state in which it is bent in accordance with a shape of the housing 2 (see FIG. 6, etc.).

While the silicone tube 30 is a tubular member made of silicone and has flexibility and light-transmitting property, it has a thickness and translucency such that the LED unit incorporated therein is not visible from the outside. A cross-sectional shape of the silicone tube 30 is a shape resembling a fluorescent lamp or a neon tube, and for example, an outer shape thereof is approximately circular except for a side facing the housing 2 (see FIG. 4, etc.). A color of the silicone tube 30 is preferably milky white, for example. A light diffusing material is preferably contained in a material (dimethylpolysiloxane) of the silicone tube.

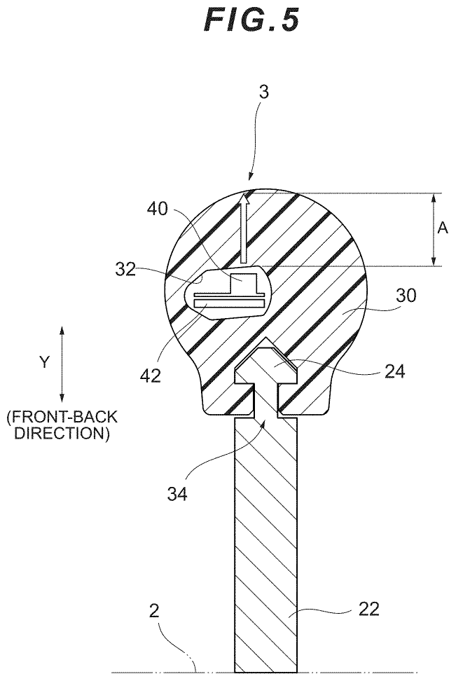

The silicone tube 30 has a receiving hole 32 formed of an elongated hole that can receive the LED 40 and its substrate 42 (see FIGS. 4 and 5). The receiving hole 32 is formed of a non-circular hole having a width that is narrower in the thickness direction of the substrate 42 and is configured such that the received substrate 42 does not change posture (direction) in the receiving hole 32. The LED unit configured of the LED 40 and the substrate 42 is provided in the silicone tube 30 by being inserted into the receiving hole 32 from an end face of the silicone tube 30.

In the housing 2, the installation members 22 for installing the silicone tubes 30 are provided along installation locations of the silicone tubes 30. Although specific structures of the installation members 22 are not particularly limited, for example, the present embodiment is configured such that an installation protrusion 24 is provided on a tip edge portion of a rail-shaped installation member 22 protruding from a surface of the housing 2, and the silicone tube 30 can be installed using the installation protrusion 24 (see FIG. 4, etc.). Further, in the present embodiment, the installation protrusion 24 has a shape in which a tip in a cross-section is pointed like a hook or wedge, and the silicone tube 30 is provided with a groove-shaped attachment groove 34. When the attachment groove 34 is made as a groove having the same shape as the cross-sectional shape of the installation protrusion 24, the silicone tube 30 can be more easily installed and can be prevented from falling off. A side of the silicone tube 30 facing the housing 2 is thick, and the attachment groove 34 is provided in the thick portion (see FIG. 4, etc.).

The installation members 22 in the game device 1 of the present embodiment are provided on upper and lower sides and left and right sides of the housing 2 to surround the game display unit 60 and the operation input unit 70. In addition, in the installation member 22, the installation protrusion 24 is provided to be curved or bent in a lateral direction (X direction), a front to rear direction (Y direction), or a vertical direction (Z direction) of the housing 2 in accordance with at least one of the shape of the housing 2 and the form of the silicone tube 30 when installed in the housing 2.

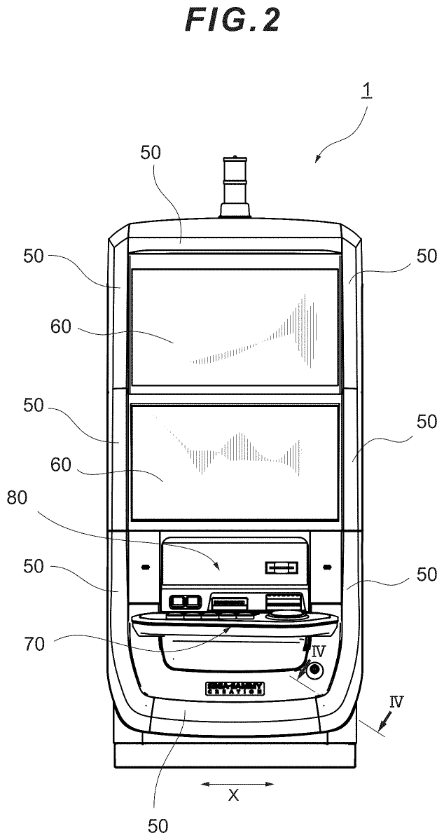

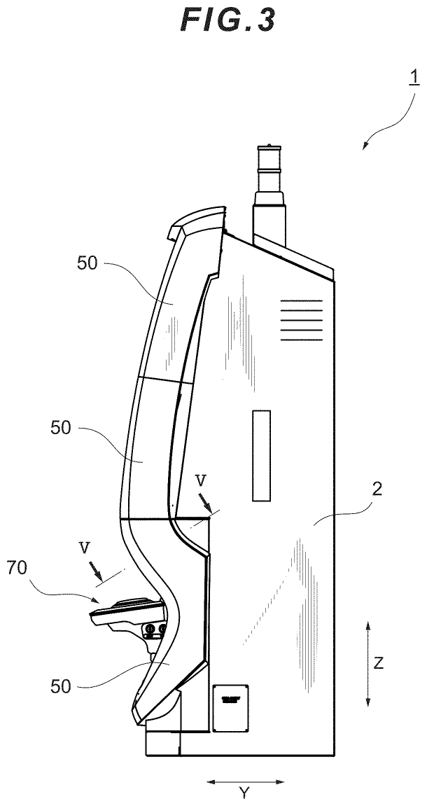

Further, the receiving hole 32 in the silicone tube 30 is formed in a direction in which a width thereof is narrower in the direction in which the substrate 42 is curved in accordance with the bending of the silicone tube 30 when installed in the housing 2. For example, in the silicone tube 30 at a portion that bends in the lateral direction (X direction), for example, in the vicinity of a lower right portion of the housing 2, the receiving hole 32 is formed to be narrower in the X direction (see FIGS. 2 and 4). The substrate 42 received in the receiving hole 32 can bend in the lateral direction (X direction). Also, in the silicone tube 30 at a portion that bends in the front to rear direction (Y direction) in the vicinity of both sides of the operation input unit 70 and the bill insertion/card reader unit 80, the receiving hole 32 is formed to be narrower in the Y direction (see FIGS. 3 and 5). The substrate 42 received in the receiving hole 32 can be curved in the front to rear direction (Y direction).

Also, although the portion that is curved only in the lateral direction (X direction) such as in the vicinity of the IV-IV line in FIG. 2 and the portion that is curved only in the front to rear direction (Y direction) such as in the vicinity of the V-V line in FIG. 3 have been used as examples here so that the explanation is easier to understand, various other forms are also possible. For example, at a portion that is curved in both the lateral direction (X direction) and the front to rear direction (Y direction), the receiving hole 32 may be formed in an oblique direction (in a direction between FIGS. 4 and 5) in accordance with a degree of bending in both directions (see the receiving hole 32 indicated by an imaginary line in FIG. 4). In this case, the silicone tube 30 and the substrate 42 may be curved together in the X direction and the Y direction by utilizing a twistable part resulting from the flexibility of the silicone tube 30 and the substrate 42.

Moreover, when a distance from a radiating position of the LED 40 in the receiving hole 32 to an outer circumferential surface of the silicone tube 30 in a light radiating direction is defined as A, the receiving hole 32 in the silicone tube 30 is formed in a position, size, and shape where A becomes at least a predetermined value (see FIGS. 4 and 5). By setting the distance A to at least the predetermined value and securing a certain thickness from the LED 40 to the outer circumferential surface of the silicone tube 30, the radiated light can be diffused inside the silicone tube 30, thereby enabling the entire silicone tube 30 to be seen by emitting light. In this case the viewer cannot easily visually recognize the presence of the LED 40 serving as a point light source from the outside, and it is possible to give an impression of an illumination resembling a fluorescent tube or neon tube shining. In view of this, the distance A is a numerical value that can change in accordance with various factors such as a material of the tube and a brightness of the light source, and is not limited to a specific numerical value.

In the above game device, the installation member 22 may be formed of a transparent member. By using the transparent installation member 22, a configuration in which the silicone tube 30 appears to float from the housing 2 can be realized. In this case, it is possible to further create the feeling of the attached illumination floating on the machine and shining like a fluorescent tube or a neon tube.

The supporting member 28 is a protruding member provided at a plurality of locations of the housing 2 and has a hole into which an end portion of the silicone tube 30 is inserted. By inserting end portions of the adjacent silicone tubes 30 opposite to each other into the hole of the supporting member 28 with their center positions aligned, it is possible to produce an effect of both tubes being connected and appearing as a single silicone tube. In the present embodiment, by connecting a plurality of silicone tubes 30 using a plurality of supporting members 28, the silicone tubes 30 disposed on both sides and the lower side of the housing 2 are configured to be able to be seen as continuous (see FIG. 6).

As described above, the supporting member 28 is a member that supports the end portion of the silicone tube 30 and covers an end face of each jointed silicone tube 30. Actually, it is difficult to adopt the elongated silicone tube 30 and to slide the elongated substrate 42 into the receiving hole 32 to be incorporated therein. However, in the structure described above, a plurality of silicone tubes 30 and substrates 42 having appropriate lengths can be employed. Although not specifically shown, wirings for power supply to the LEDs 40 can be disposed inside the supporting members 28.

The cover member 50 is a member formed of acrylic resin, glass, or the like that is attached to the housing 2 to cover the silicone tube 30 (see FIG. 1, etc.). According to the cover member 50, it is possible to produce an effect of a cover (a lamp cover) covering the light emitting device 3 which is a light emitting body resembling a fluorescent tube or a neon tube and preventing heat and cracks. Also, for example, by adopting a translucent cover member 50 made of black glass, the light of the silicone tube 30 can also be made to shine uniquely (for example, luminescence with a bewitching impression, luminescence that creates a colorful atmosphere or a classy atmosphere, luminescence that creates an elegant and stylish atmosphere like a social hall, luminescence that creates a futuristic atmosphere, luminescence that creates a nostalgic atmosphere, etc.).

Also, it should be understood that the above-described embodiment is an example of a preferred embodiment of the present invention and the present invention is not limited thereto, and various modifications can be made without departing from the scope of the present invention. For example, although the example in which the light source is configured of the LEDs has been described in the above-described embodiment, this is merely a preferable example and other light sources can be used.

Also, although the example in which the installation member 22 is provided with the convex installation protrusion 24 and the silicone tube 30 is provided with the concave attachment groove 34 has been described in the above-described embodiment, this is merely a preferred example. Conversely, a convex attachment member can be provided on the silicone tube 30, and a concave attachment member can be provided on the installation member 22.

Also, the silicone tube 30 described in the above-described embodiment is merely an appropriate example of a tubular member that constitutes the light emitting device 3 or the game device 1 including the light emitting device 3. As the tubular member, a tube body made of something other than silicone can be used. Further, as the tubular member, a cylindrical object having a C-shaped cross section with a notch on a side surface thereof can be used.

### INDUSTRIAL APPLICABILITY

The present invention is suitable for application to a game device having a housing and a light emitting device therefor.

### REFERENCE SIGNS LIST

1 Game device
2 Housing
3 Light emitting device
22 Installation member
24 Installation protrusion
30 Silicon tube (tubular member)
32 Receiving hole
34 Attachment groove (attachment portion)
40 LED (light source)
42 Substrate
50 Cover member

1. A game device including a housing, comprising:
a tubular member having flexibility and light-transmitting property; and
a light source disposed in the tubular member.

2. The game device according to claim 1, wherein an installation member on which the tubular member is installed is provided on the housing.

3. The game device according to claim 2, wherein an installation protrusion is provided on the installation member, and an attachment portion for installing the tubular member on the installation member is configured by a groove having the same shape as a cross-sectional shape of the installation protrusion.

4. The game device according to claim 3, wherein the light source is provided on a bendable substrate.

5. The game device according to claim 4,
wherein a receiving hole which receives the substrate and the light source is formed in the tubular member; and
the receiving hole has a width that is narrower in a thickness direction of the substrate.

6. The game device according to claim 5, wherein the installation member is transparent.

7. The game device according to claim 6, further comprising a translucent or opaque cover member which covers the tubular member.

8. The game device according to claim 7, wherein the tubular member is a silicone tube and contains a light diffusing material.
